(19) United States
(12) Patent Application Publication
(10) Pub. No.: US 2008/0135691 A1
(43) Pub. Date: Jun. 12, 2008

(54) Securing system

(75) Inventor: Brian Buck, Jackson, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Anvil International, LP.

(21) Appl. No.: 12/001,409

(22) Filed: Dec. 11, 2007

Related U.S. Application Data
(60) Provisional application No. 60/869,406, filed on Dec. 11, 2006.

(51) Int. Cl. F16L 3/00

(52) U.S. Cl. 248/62

(57) ABSTRACT

Embodiments of present invention generally relate to securing systems and, more particularly, to clamping assemblies for supporting items such as piping systems and mechanical systems. In one embodiment, a hanger assembly for pipes or other equipment in a building is provided. The hanger assembly includes a clamping assembly configured to releaseably engage a support structure secured to the building; a hanger for supporting the pipes or other equipment in the building; and an elongate rod having a first end and a second end, wherein the first end is coupled to the clamping assembly such that the elongate rod can pivot in a plurality of planes and wherein the second end is configured to support the hanger.

### CROSS-REFERENCE TO RELATED APPLICATIONS

This application claims the benefit of U.S. Provisional Application No. 60/869,406, entitled Securing System, filed Dec. 11, 2006, which is incorporated by reference herein in its entirety.

### BACKGROUND OF THE INVENTION

1. Field of the Invention

Embodiments of present invention generally relate to hanger assemblies for pipes or other equipment in buildings.

2. Description of the Prior Art

A clamp is a fastening device used to hold or secure objects and discourage movement or separation in the event of external pressure. Clamps are well known in the art, and C-clamps are one of the most common types of clamps. C-clamps have a substantially C-shaped frame and are often made of steel or cast iron. C-clamps typically include a screw that extends through a portion of the frame where the screw may be tightened until a desired state is obtained.

Some companies have adapted C-clamps to provide a mechanism for supporting items beneath a structure engaged by the C-clamp. FIGS. 1-3 illustrate a C-clamp system 2 adapted to provide a mechanism for supporting an accumulation of cables 4 The conventional C-clamp system 2, as shown in FIGS. 1-3, is Erico's CADDY Beam Clamp Model BC10. FIG. 1 shows two identical conventional C-clamp systems 2 engaging a beam 6 and C-shaped hanger bar 21. Each C-clamp system 2 includes a C-clamp 8 for securing the system to the beam 6, an elongate rod 12 extending downward from the C-clamp 8, and a pivoting point 10 for pivoting the elongate rod 12 about the C-clamp 8. The C-clamp 8 is releasably securable to the beam 6. The pivoting point 10 is carried by the C-clamp 8, and includes a bolt/pin 14 for connecting the C-clamp 8 to a U-member 16. As a result, the U-member 16 can pivot about the bolt/pin 14. The elongate rod 12 includes a first end 18 connected to the U-member 16 that enables the elongate rod 12 to also pivot about the bolt/pin 14. The elongate rod 12 also includes a second end 20 that engages the C-shaped bar 21. FIG. 1 illustrates the C-shaped hanger bar 21 supporting an accumulation of cables 4 and the C-shaped hanger bar 21 being supported by two conventional C-clamping systems 2. Although the C-shaped hanger bar 21 is illustrated as a hanger for cables, other building equipment could also be hung using the system including pipes, conduits and the like.

In use, the C-clamping system 2 is tightened when the objects, such as the beam 6, are satisfactorily positioned between the flat end of the screw 22 and a flat end of the C-clamp 2. The C-clamping system 2 may also be loosened to allow the C-clamping system 2 to be removed from a structure, which in this case is the beam 6.

In the conventional C-clamping system 2, the pivoting point 10 limits the movement of the elongate rod 12 within a single plane. Also, the pivoting point 10 restricts the pivotal movement of the rod to a single plane. As a result, the C-clamping system 2 may not allow the elongate rod to be plumb with respect to gravity if the surfaces of the structure engaged by the C-clamping system 2 are not substantially perpendicular to the direction of gravity. The elongate rod may be subjected to a bending stress because the joint between the rod and the C-clamping system 2 restricts the pivotal movement of the rod to a single plane. Accordingly, this restricted pivotal movement can limit the types of structures in which conventional clamping systems can be used. A need therefore exists for securing systems that provide more flexibility on the types of structures in which items may be suspended.

### BRIEF SUMMARY OF THE INVENTION

The above and other needs are met by the present invention which, in one embodiment, provides a hanger assembly for pipes or other equipment in a building. The hanger assembly includes a clamping assembly configured to releaseably engage a support structure secured to the building; a hanger for supporting the pipes or other equipment in the building; and an elongate rod having a first end and a second end, wherein the first end is coupled to the clamping assembly such that the elongate rod can pivot in a plurality of planes and wherein the second end is configured to support the hanger.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of securing system having two conventional C-clamp systems supporting an accumulation of cables;

FIG. 2 is a perspective view of a conventional C-clamp system without the pivoting point;

FIG. 3 is a perspective view of the conventional C-clamp system shown in FIG. 2;

FIG. 4 is a side view of a securing system 100 in accordance with an embodiment of the present invention;

FIG. 5 is a perspective view of a ball joint 300 in accordance with an embodiment of the present invention;

FIG. 6 is a perspective view of the cage 305 shown in FIG. 5;

FIG. 7 is an exploded view of a cage 500 in accordance with an embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

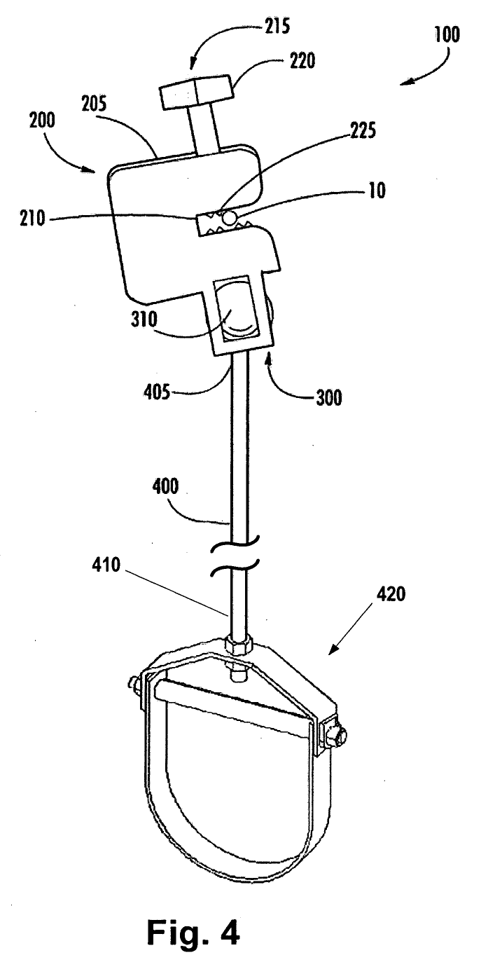

FIG. 4 illustrates a securing system 100 in accordance with an embodiment of the present invention engaging a structure 10. The securing system 100 includes a clamping assembly 200, a ball joint 300, and an elongate rod 400. The clamping assembly 200 is removeably securable to the structure 10, such that the clamping assembly 200 can bitingly engage the structure 10. The ball joint 300 is carried by the clamping assembly 200 and enables the elongate rod 400 to swivel about the ball joint 300. The elongate rod 400 has a first end 405 and a second end 410. The first end 405 of the elongate rod 400 is carried by the ball joint 300, while the second end 410 may be configured with a conventional pipe strap for securing a piping system as illustrated in FIG. 4. Because the elongate rod 400 can swivel about the ball joint 300, the elongate rod 400 hangs substantially plumb with the direction of gravity in a relaxed state.

The swiveling action at the ball joint 300, allows the securing system 100 to overcome deficiencies in conventional C-clamping systems. Specifically, it enables the elongate rod 400 to hang in substantial alignment with the direction of gravity (i.e. plumb) substantially independent from the angle of the surface to which the clamping assembly 200 engages.

As mentioned, the securing system 100 is configured to connect to a structure 10. The structure 10 may take a variety of forms, such as for example a beam, steel joist, or other common steel structural shape. As noted above, one advantage of using securing assembly 100 is that it may clamp to structural surfaces of varying angles. For example, the structure 10 may be a truss support for a building, which is situated at an angle other than horizontal. The swiveling action of the ball joint enables the securing system 100 to be secured to such structures while still allowing the elongate rod 400 to hang substantially plumb.

The clamping assembly 200 of the securing system 100 includes a clamp 205 having a notch 210 for receiving the structure 10 therein. The clamp 205 of the clamping assembly 200 may have a substantially C-shape. That is, the clamping assembly 200 may be a C-clamp, although as one skilled in the art would appreciate, other shaped clamps may be used in connection with embodiments of the present invention.

In various embodiments, the clamp 205 is configured to releaseably engage opposing surfaces of the structure 10. In one embodiment, the clamp 205 includes a clamping adjustment assembly 215. The clamping adjustment assembly 215, in the illustrated embodiment, is a load screw 220. The load screw 220 may be a reduced neck bolt. As the load screw 220 is tightened, the clamp 205 engages the structure 10. On the other hand, as the load screw 220 is loosened, the clamp 205 disengages the structure 10 and may be removed or repositioned on the structure. In an exemplary embodiment, the load screw 220 directly engages the structure 10, such that the load screw 220 secures the clamp 205 to the structure 10. In an alternative embodiment, the load screw 220 enables the clamp 205 to directly engage the structure 10, by adjusting the size of the notch 210.

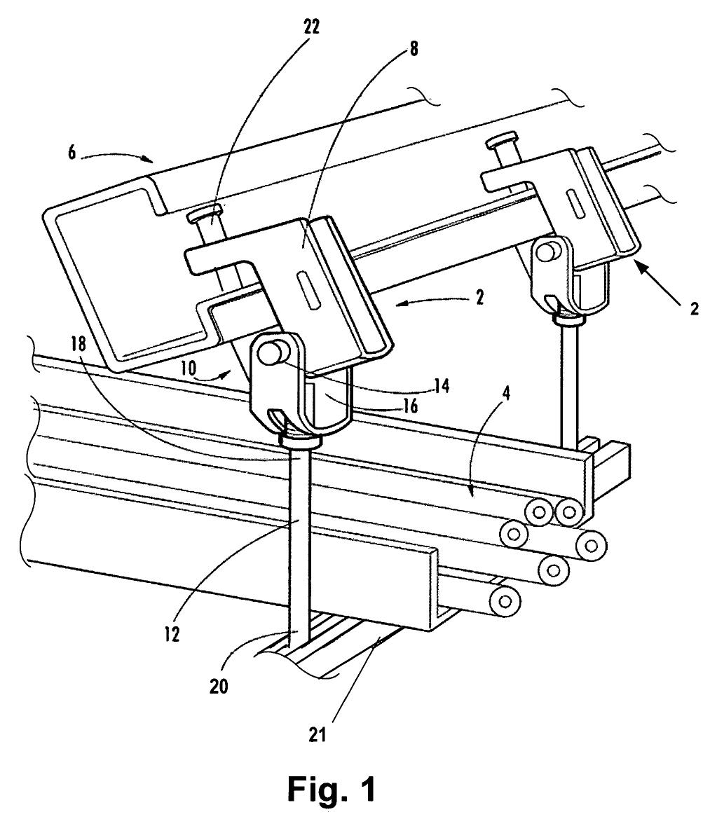

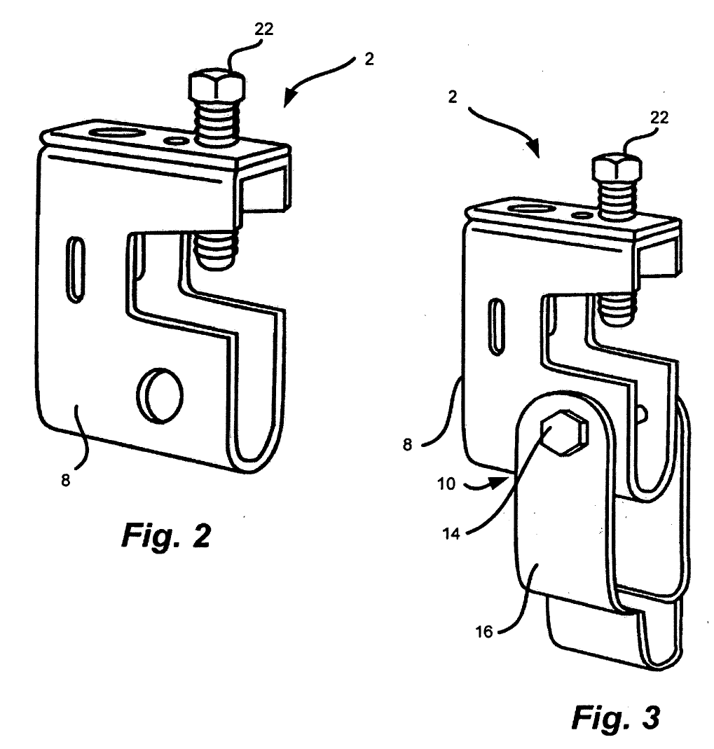

In various embodiments, the notch 210 of the clamp 205 includes a plurality of teeth 225. As the clamping adjustment assembly 215 is tightened against the structure 10, the teeth 225 may further engage the structure 10 for additional support. Although illustrated in FIG. 4 as engaging a rod-shaped structure 10, the clamp 205 can engage other shaped structures such as the beam 6 illustrated in FIG. 1.

The ball joint 300 of the securing system 100 enables the elongate rod 400 to swivel approximately 360 degrees within a conical volume. Further, the ball joint 300 may also reduce the chance that the elongate rod 400 will be subjected to a bending stress while the securing system 100 is attached to the structure 10.

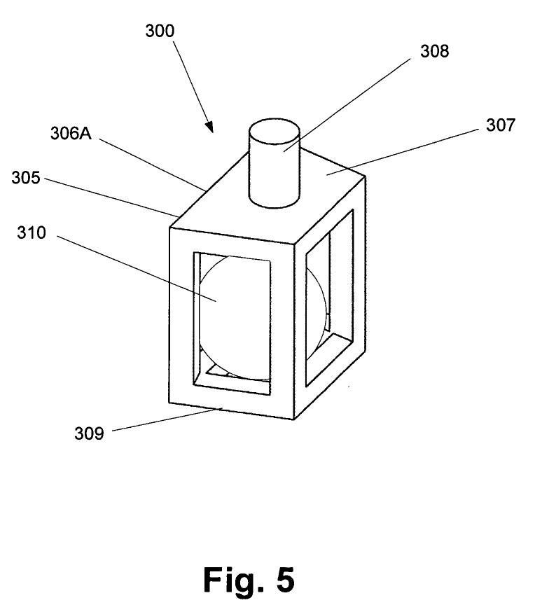

Turning to FIG. 5, the ball joint 300 includes a cage 305 and a ball 310. The cage 305 is configured to receive the ball 310 therein.

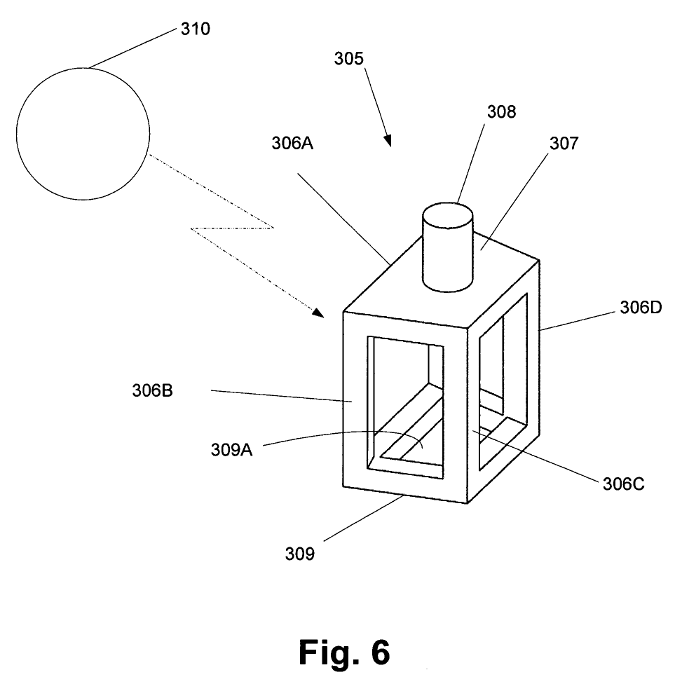

FIG. 6 illustrates an embodiment of the cage 305. The cage 305 includes four sidewalls 306A,B,C,D, which cooperate to form a trapezoid. It should be understood that the sidewalls 306A,B,C,D may be configured in other prismatic shapes such as a cube or inverted pyramid. Each of the sidewalls 306A,B,C,D define a window. The window defined by the longest sidewall 306A of the trapezoid is large enough to allow the ball 310 to pass through. In the illustrated embodiment, the other widows defined by the remaining sidewalls 306B,C,D are sized such that the ball 310 will not pass through. As will be understood by those of skill in the art, the windows defined by the other sidewalls may be large enough to allow the ball 310 to pass through if desired.

The cage 305 also includes a substantially planar top 307, which has a substantially trapezoidal shape. The planar top 305 is configured to secure the cage 305 to the clamping assembly 200. In the illustrated embodiment, the planar top 307 includes a threaded pin 308, which is configured to engage a threaded hole formed in the clamp assembly 200. In other embodiments, the planar top 308 may define a hole configured to accept a fastener, which may be used to secure the cage 305 to the clamp assembly 200. It should be understood that the cage 305 may be secured to the clamp assembly 200 using any known or developed method of fastening.

In the illustrated embodiment, the bottom wall 309 is a planar structure substantially parallel with the top 307 and defines an opening 309A. The opening 309A is smaller than the ball 310 such that the ball 310 cannot pass through. The opening 309A is also large enough to allow the first end of the elongate rod 400 to pass through and engage the ball 310.

In a further embodiment, the sidewall 306A of the cage 305 is adapted to receive the ball 310 there through, as well as the elongate rod 400 as discussed in greater detail below. In further embodiments, the side 306A may have a hinged door (not shown) for securing the ball 310 inside the cage 305.

In other embodiments, a retaining screw (not shown) may be installed in a sidewall 306A of the cage 305 to retain the ball 310 within the cage 305. The retaining screw may be configured to engage the sidewall 306A of the cage 305 and protrude into the side window defined by the sidewall 306A of the cage 305 thereby reducing, if not eliminating, the clearance that enables the ball 310 to be inserted into or withdrawn from the cage 305. The retaining screw may be adjusted to prevent the ball 310 from being removed from the cage 305.

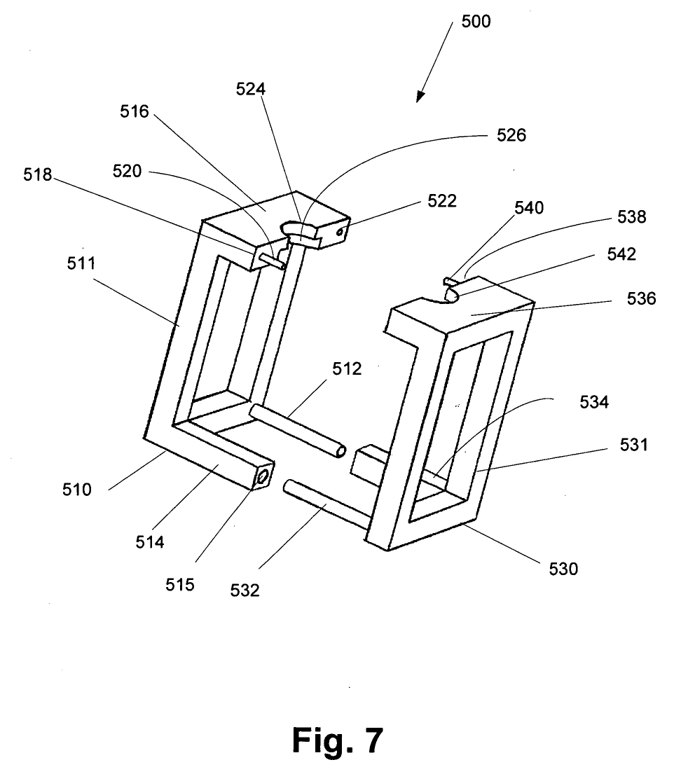

FIG. 7 illustrates another embodiment of a cage 500. In this embodiment, the cage 500 includes a first half 510 and a second half 530. These two halves may be joined to create a cube shaped cage 500. Generally described, the two halves utilize a series of pins and associated apertures to align and secure the two halves to form the cage 500.

The first half 510 includes a sidewall 511, which defines a window. Extending perpendicularly from the sidewall 511 are a pin 512 and a leg 514. The leg 514 defines an aperture 515, which is substantially aligned with the elongate axis of the leg 514. The pin 512 and leg 514 are located proximate the bottom of the sidewall 511 and are substantially parallel.

Extending substantially perpendicular from the top of the sidewall 511 is a top wall 516. A pin 520 extends from the edge 518 of the top wall 516. The edge 518 also defines an aperture 522 spaced apart from the pin 520 such that the axis of the aperture 522 is substantially parallel with the elongate axis of the pin 520. Additionally, the edge 518 defines an arcuate portion 524 and a hex portion 526 which are in substantial vertical alignment and configured to engage the shoulder and head of a fastener (not shown) respectively when the two halves 510, 530 are joined.

The second half 530 includes a sidewall 531, which defines a window. Extending perpendicularly from the sidewall 531 are a pin 532 and a leg 534. The leg 534 defines an aperture (not shown), which is substantially aligned with the elongate axis of the leg 534. The pin 532 is configured to engage the aperture 515 defined by the leg 514 of the first half 510, and the aperture (not shown) in the leg 534 is configured to receive the pin 512 of the first half 510 when the two halves 510, 530 are joined.

Extending substantially perpendicular from the top of the sidewall 531 is a top wall 536. A pin 540 extends from the edge 538 of the top wall 536 and is configured to engage the aperture 522 of the first half 510. The edge 538 also defines an aperture (not shown) which is configured to receive the pin 520 from the first half 510. Additionally, the edge 538 defines an arcuate portion 542 and a hex portion (not shown), which are in substantial vertical alignment and configured to engage the head and shoulder of a fastener when the two halves 510, 530 are joined. When joined, the two legs 514 and 534 define the bottom of the cage 500 and are space apart such that the ball 310 (not shown) cannot pass through. In one embodiment, the ball 310 is placed between the two halves 510, 530 before the halves are joined such that the ball 310 is captured by the cage 500. As will be understood by those of skill in the art, adhesives may be used in conjunction with the pins and apertures to secure the two halves together. In other embodiments, some of the pins and associated apertures may be designed for a press or snap fit.

Returning to FIG. 4, the ball 310 is connected to the first end of the elongate rod 400 thereby enabling swiveling attributes. In various embodiments, the ball 310 is integral with the elongate rod 400. In other embodiments, the ball 310 may include a threaded aperture for receiving the elongate rod 400, which would have a complementary threaded portion proximate the first end 405, such that the threads on the first end 405 of the elongate rod 400 cooperate with the threaded aperture in the ball 310 to secure the elongate rod 400 to the ball 310.

The open bottom 309 coupled with the shape of the ball 310 allow the elongate rod 400 to swivel about the ball joint 300. The elongate rod 400 can be suspended within a 360 degree conical section. Plus, when the elongate rod 400 is in a relaxed state, it hangs substantially plumb. Notably, the elongate rod 400 hangs plumb in the relaxed state due to the prevailing forces of gravity.

The second end 410 of the elongate rod 400 is configured to secure an item or other securing mechanisms. In the embodiment illustrated in FIG. 4, the second end 410 is configured with a conventional pipe strap 420. As one skilled in the art would appreciate, the second end 410 of the elongate rod 400 can be configured to support many types of systems such as piping systems, mechanical equipment, air flow ducts, electrical conduits, and the like. Any known or developed mechanisms may be used to secure the elongate rod 400 to the system being supported.

In one aspect of the invention, various methods are provided for securing objects to a structure. In one exemplary embodiment, the clamping assembly 200 is attached to a structure 10 by tightening the clamping adjustment assembly 215. Then, the elongate rod 400 is attached to the ball 310 and the second end 410 of the elongate rod 400 is threaded through the sidewall 306A and the opening 309A defined by the bottom wall 309 such that the ball 310 rests within the cage 305, and the elongate rod 400 extends from the ball 310 through the bottom wall 309. Next, an item or retaining mechanism may be secured to the second end 410 of the elongate rod 400 such as a pipe strap 420.

In other embodiments, the rod 400 and ball 310 may be inserted into the cage 305 prior to attaching the clamping assembly 200 to the structure 10. In further embodiments, the ball 310 may be placed within the cage 305 prior to attachment to the elongate rod 400. In which case, the elongate rod 400 would be extended from outside the cage 305 through the opening 309A defined by the bottom 309 and engage the ball 310.

In still further embodiments, a clamping assembly 200 may be attached to the structure first, and then the cage 305 fastened to the clamp assembly 200. Next, the ball may be placed into the cage before or after the attachment of the cage to the clamp assembly 200.

A beneficial feature of the securing system 100 is that depending on the length of the elongate rod 400, the securing system 100 may be secured to a non-horizontally angled structure but still support a horizontal piping system. In addition, the securing system 100 has the flexibility to be secured to a horizontal structure and support a non-horizontal or horizontal piping system.

An additional benefit of embodiments of the present invention is that the second end 410 of the elongate rod 400 may be configured to support a piping system as shown in FIG. 4, which may allow limited movement of the piping system in response to non-vertical forces, such as seismic forces and/or wind loads. In particular, the swiveling action of the ball joint 300 may allow some movement without placing a bending stress on the elongate rod 400. Other bracing (not shown) may also be included at the connection between the second end of the elongate rod 400 and the piping system, for further restraint and support of the piping system from moving in a non-horizontal direction (e.g., discourage pivoting about the ball joint).

A benefit of various embodiments of the present invention is that they may enable an elongate rod to be suspended in a 360 degree conical section, by utilizing a clamping assembly carrying a ball joint in communication with the elongate rod. As a result, the clamping assemblies may be attached to a horizontal or non-horizontal structure, such that the elongate rod hangs plumb, which promotes proper support and flow of various piping systems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hanger assembly for pipes or other equipment in a building, the hanger assembly comprising:
a clamping assembly configured to releaseably engage a support structure secured to the building;
a hanger for supporting the pipes or other equipment in the building; and
an elongate rod having a first end and a second end, wherein the first end is coupled to the clamping assembly such that the elongate rod can pivot in a plurality of planes and wherein the second end is configured to support the hanger.

2. The hanger assembly of claim 1, wherein the elongate rod is coupled to the clamping assembly by a ball joint.

3. The hanger assembly of claim 2, wherein the ball joint comprises a cage portion coupled to the clamping assembly and a ball portion connected to the first end of the elongate rod, and wherein the cage portion defines a cavity configured to receive the ball therein.

4. The hanger assembly of claim 3, wherein the ball portion defines a threaded aperture and the first end of the rod has a threaded portion, and wherein the threaded aperture and the threaded portion of the first end cooperate to connect the ball portion to the elongate rod.

5. The hanger assembly of claim 3, wherein the cage portion includes a locking screw configured to discourage the ball from exiting the cage.

6. The hanger assembly of claim 1, wherein in the clamping assembly is substantially C-shaped.

7. The hanger assembly of claim 6, wherein the clamping assembly includes teeth that are configured to selectively engage the support structure.

8. The hanger assembly of claim 1, wherein the elongate rod has the ability to pivot in a 360 degree conical section wherein the apex of the conical section is located proximate the ball joint.

9. The hanger assembly of claim 3, wherein the cage comprises two halves and wherein one of said two halves includes a pin and the other of said two halves includes an aperture configured to receive said pin when said two halves are joined to form the cage.
